(19) United States
(12) Patent Application Publication
(10) Pub. No.: US 2011/0188423 A1
(43) Pub. Date: Aug. 4, 2011

(54) MULTI-MODE TERMINAL, SYSTEM, AND METHOD

(75) Inventor: Jae Hoon KIM, Seoul (KR)

(73) Assignee: Pantech Co., Ltd., Seoul (KR)

(21) Appl. No.: 13/006,257

(22) Filed: Jan. 13, 2011

(30) Foreign Application Priority Data
Jan. 29, 2010 (KR) 10-2010-0008606

(51) Int. Cl. H04W 52/02

(52) U.S. Cl. 370/311

(57) ABSTRACT

Disclosed herein is a system and method for reducing power consumption of a multi-mode terminal, which can decrease power consumption of a multi-mode terminal that supports mobile communication and wireless local area network (LAN) functions and increase efficiency of the wireless LAN function. To this end, power is cut off or a low-power state is maintained if a wireless LAN service is not used, and power is applied to a wireless LAN modem if a user requests or a call reception message is received through a mobile communication modem.

### CROSS-REFERENCE TO RELATED APPLICATION

This application claims priority from and the benefit under 35 U.S.C. §119(a) of Korean Patent Application No. 10-2010-0008606, filed on Jan. 29, 2010, which is hereby incorporated by reference for all purposes as if fully set forth herein.

### BACKGROUND

1. Field

Disclosed herein is a system and method for reducing power consumption of a multi-mode terminal and increase efficiency of a wireless LAN.

2. Discussion of the Background

In general, a wireless local area network (LAN) is a flexible data communication network system implemented as a replacement or extension of wired LAN. The wireless LAN enables data communications using a radio frequency technique without a wired network.

In the wireless LAN, terminals, each having a wireless LAN modem built therein, are connected to an access point (AP) so that wireless communications are performed.

Meanwhile, as communication technologies are developed, a wireless LAN modem is incorporated a mobile communication terminal with incorporated mobile communication mode, which provides mobile communication services, thereby providing not only a voice communication service but also a packet data service and providing an internet telephony service through combination of the voice over internet protocol (VoIP) technology.

A multi-mode terminal having a mobile communication modem and a wireless LAN modem necessarily maintains the mobile communication modem and the wireless LAN modem to be always in an on-state so as to provide the mobile communication service and the packet data service thereby increasing power consumption.

In order to solve such a problem, conventionally, power is applied to the wireless LAN modem only when a multi-mode terminal is located in a wireless LAN service area, and the power applied to the wireless LAN modem is cut off when the multi-mode terminal is located out of the wireless LAN service area.

However, although power is applied to the wireless LAN modem only if the multi-mode terminal is located in the wireless LAN service area as described above, the multi-mode terminal necessarily checks whether or not it is located in the wireless LAN service area by periodically searching the AP while the power is applied to the wireless LAN modem thereby consuming power.

In order to solve such a problem, the amount of data is determined on a mobile communication network, and data communications are performed through the wireless LAN only when the amount of data is large. However, if the data communications are performed through the wireless LAN only when the amount of data is large as described above, the mobile communication network uses the Internet Protocol (IP) address of the multi-mode terminal so as to set the connection of the multi-mode terminal. Since the IP address of the multi-mode terminal connected to the wireless LAN may be changed, a method for controlling the IP address of the multi-mode terminal is additionally required.

### SUMMARY

Exemplary embodiments of the present invention provide a system and method for reducing power consumption of a multi-mode terminal, in which power is cut off or a low-power state is maintained if a wireless local area network (LAN) service is not used, and a wireless LAN modem is activated based on a request of a user or a call reception message received through a mobile communication modem, thereby decreasing power consumption of the multi-mode terminal and increasing efficiency of the wireless LAN functions.

Additional features of the invention will be set forth in the description which follows, and in part will be apparent from the description, or may be learned by practice of the invention.

An exemplary embodiment provides a system for reducing power consumption of a multi-mode terminal, the system including: a multi-mode terminal having a mobile communication modem and a wireless LAN modem; a mobile communication network system that provides a mobile communication service; and a wireless LAN communication network system that provides a packet data service, wherein, if the wireless LAN communication network system receives a call to the multi-mode terminal, the wireless LAN communication network system transmits a call reception message to the mobile communication network system, and the mobile communication network system transmits the call reception message received from the wireless LAN communication network system to the multi-mode terminal; and if the multi-mode terminal receives the call reception message through the mobile communication modem while the wireless LAN modem is in a low-power state, the multi-mode terminal activates the wireless LAN modem by applying power to the wireless LAN modem.

An exemplary embodiment provides multi-mode terminal including: a wireless LAN modem connected to a wireless LAN communication network system through a wireless LAN access point (AP) to perform communications; a mobile communication modem connected to a mobile communication network system to perform communications; and a wireless LAN connection management unit to activate a wireless LAN modem by applying power to the wireless LAN modem if the wireless LAN connection management unit receives a call reception message through the mobile communication modem while the wireless LAN modem is in a low-power state, wherein the activated wireless LAN modem performs location registration and sets a call based on the call setting message received from the wireless LAN communication network system.

An exemplary embodiment provides a method for reducing power consumption of a multi-mode terminal, the method including: activating a wireless LAN modem of a transmitting multi-mode terminal by applying power to the wireless LAN modem in response to a call setting request inputted from a user to use a packet data service; performing location registration through the activated wireless LAN modem of the transmitting multi-mode terminal and transmitting a call to a wireless LAN communication network system; transmitting a call reception message from the wireless LAN communication network system that receives the call to a mobile communication network system; transmitting the call reception message from the mobile communication network system to a receiving multi-mode terminal; activating a wireless LAN modem of the receiving multi-mode terminal by applying power to the wireless LAN modem of the receiving multi-mode terminal; and performing location registration through the activated wireless LAN modem of the receiving multi-mode terminal and setting a call with the transmitting multi-mode terminal based on the call setting message received from the wireless LAN communication network system.

An exemplary embodiment provides a method for reducing power consumption of a multi-mode terminal, the method including: receiving in a receiving multi-mode terminal a call reception message from a mobile communication network system through a mobile communication modem; activating a wireless LAN modem of the receiving multi-mode terminal by applying power to the wireless LAN modem of the receiving multi-mode terminal based on the received call reception message; performing location registration through the activated wireless LAN modem of the receiving multi-mode terminal; and receiving in the receiving multi-mode terminal a call setting message from the wireless LAN communication network system and setting a call with a transmitting multi-mode terminal.

An exemplary embodiment provides In one embodiment, there is provided a system for reducing power consumption of a multi-mode terminal, the system including: a multi-mode terminal having a mobile communication modem and a wireless local area network (LAN) modem; a mobile communication network system that provides a mobile communication service; and a wireless LAN communication network system that provides a packet data service, wherein: if the wireless LAN communication network system receives a call to the multi-mode terminal, the wireless LAN communication network system transmits a call reception message to the mobile communication network system, and the mobile communication network system transmits the call reception message received from the wireless LAN communication network system to the multi-mode terminal; and if the multi-mode terminal receives a call setting request from a user to use the packet data service while the wireless LAN modem is in a low-power state, the multi-mode terminal activates the wireless LAN modem by applying power to the wireless LAN modem.

An exemplary embodiment provides multi-mode terminal including: a wireless LAN modem connected to a wireless LAN communication network system through a wireless LAN access point (AP) to perform communications; a mobile communication modem connected to a mobile communication network system to perform communications; and a wireless LAN connection management unit to activate a wireless LAN modem by applying power to the wireless LAN modem if the wireless LAN connection management unit receives a call setting request from a user to use a packet data service while the wireless LAN modem is in a low-power state, wherein the activated wireless LAN modem performs location registration and sets a call based on the call setting message received from the wireless LAN communication network system.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view of a system according to an exemplary embodiment.

FIG. 2 is a schematic view of a multi-mode terminal according to an exemplary embodiment.

FIG. 3 is a flowchart illustrating a method for reducing power consumption of a multi-mode terminal according to an exemplary embodiment.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size, and regions, and the like, of the drawing may be exaggerated for clarity.

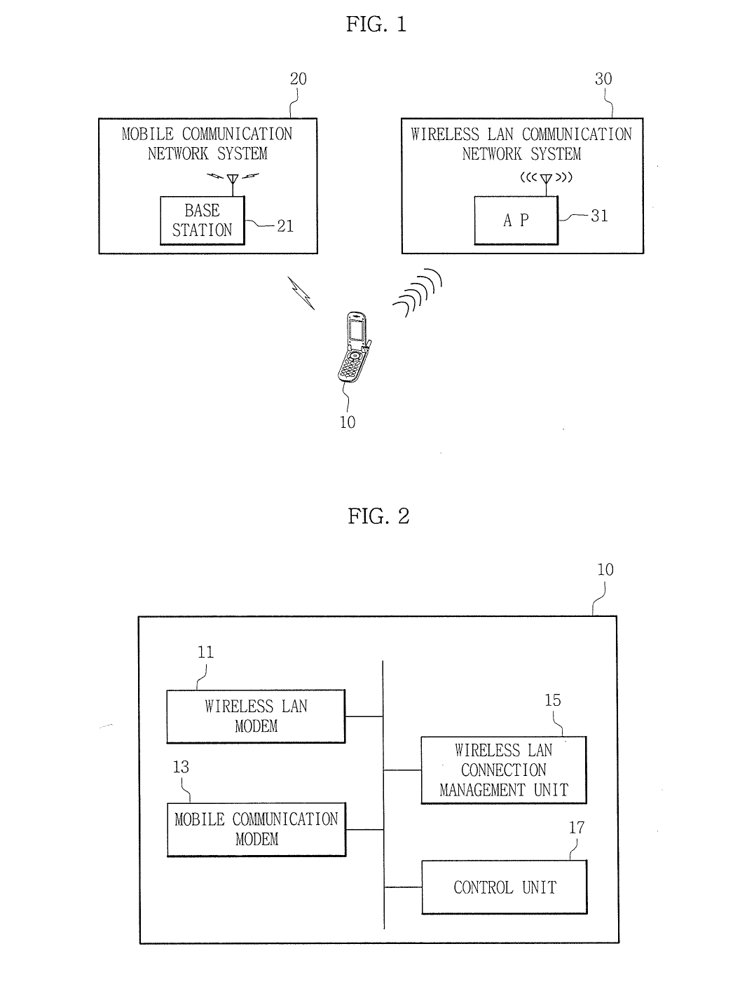

FIG. 1 is a schematic view of a system according to an exemplary embodiment. In FIG. 1, a multi-mode terminal 10 includes a mobile communication modem (not shown) and a wireless local area network (LAN) modem (not shown).

A mobile communication network system 20 provides a mobile communication service to the multi-mode terminal 10 connected through a base station 21, and maps and stores wireless LAN identification information and mobile communication identification information assigned to the multi-mode terminal 10.

A wireless LAN communication network system 30 provides a packet data service, such as a voice over internet protocol (VoIP) internet telephony service or wireless internet service, to the multi-mode terminal 10 connected through a wireless LAN access point (AP) 31.

If the wireless LAN communication network system 30 receives a call (e.g., a VoIP call) received to the multi-mode terminal 10, the wireless LAN communication network system 30 requests a home location register (HLR) (not shown), which belongs to a wireless LAN communication network, of location information for the multi-mode terminal 10 by using identification information of the multi-mode terminal 10. If the wireless LAN communication network system 30 does not receive the location information for the multi-mode terminal 10 from the HLR as a response to the request, the wireless LAN communication network system 30 determines that the location of the corresponding multi-mode terminal 10 is not registered. Therefore, the wireless LAN communication network system 30 transmits a call reception message to the mobile communication network system 20. Here, the call reception message informs the multi-mode terminal 10 that the call (e.g., the VoIP call) has been received to the multi-mode terminal 10.

The call reception message may include identification information on a transmitting terminal (wireless LAN identification information), IP information assigned to the transmitting terminal, the kind of call tried by the transmitting terminal, and the like.

Meanwhile, the mobile communication network system 20 that receives the call reception message transmitted by the wireless LAN communication network system 30 searches the mobile communication identification information of the multi-mode terminal 10 using the wireless LAN identification information included in the call reception message and then transmits the call reception message to the multi-mode terminal 10 using the searched mobile communication identification information.

As described above, if the multi-mode terminal 10 receives a call reception message through the mobile communication network system 20 while no or little power is applied to the wireless LAN modem (i.e., maintaining a low-power state), the multi-mode terminal 10 applies power to activate the wireless LAN modem. The multi-mode terminal 10 then performs location registration to the HLR (not shown) through the wireless LAN communication network system 30 through the activated wireless LAN modem. Then, the multi-mode terminal 10 receives a call setting message from the wireless LAN communication network system 30 and sets a call (e.g., a VoIP call) with a transmitting terminal (not shown).

Thereafter, if the call (e.g., the VoIP call) set between the multi-mode terminal 10 and the transmitting terminal is released, the multi-mode terminal 10 cuts off the power applied to the wireless LAN modem (i.e., maintains the low-power state).

In addition, if the multi-mode terminal 10 receives a call setting request inputted from a user to use a packet data service, such as a VoIP internet telephony service, while no or little power is applied to the wireless LAN modem, the multi-mode terminal 10 activates the wireless LAN modem by applying power to the wireless LAN modem and then performs location registration to the HLR (not shown) through the activated wireless LAN modem. Then, the multi-mode terminal 10 transmits a call (e.g., a VoIP call) to the wireless LAN communication network system 30 in response to the call setting request.

FIG. 2 is a schematic view of a multi-mode terminal according to an exemplary embodiment. In FIG. 2, the multi-mode terminal 10 includes a wireless LAN modem 11, a mobile communication modem 13, a wireless LAN connection management unit 15, and a control unit 17. The wireless LAN modem 11 performs communications with a wireless LAN communication network system, for example, while connected to the wireless LAN communication network system 30 through the wireless LAN AP 31 as shown in FIG. 1. The wireless LAN modem 11 performs communications with the wireless LAN communication network system by performing location registration to the HLR (not shown) through the wireless LAN communication network system 30 if the wireless LAN modem 11 is activated by receiving power applied by the wireless LAN connection management unit 15.

The mobile communication modem 13 performs communications with a mobile communication network system, for example, while connected to the mobile communication network system 20 through the base station 21 as shown in FIG. 1. The mobile communication modem 13 receives a call setting message through the mobile communication network system 20 and transmits the received call setting message to the wireless LAN connection management unit 15.

If the wireless LAN connection management unit 15 receives a call setting request inputted from a user to use a packet data service or receives a call reception message from the mobile communication network system 20 through the mobile communication modem 13 while no or little power is applied to the wireless LAN modem 11, the wireless LAN connection management unit 15 activates the wireless LAN modem 11 by applying power to the wireless LAN modem 11.

If a call (e.g., a VoIP call) related to the packet data service between the wireless LAN connection management unit 15 and a transmitting terminal is released, the wireless LAN connection management unit 15 cuts off the power applied to the wireless LAN modem 11.

As described above, the wireless LAN modem 11 activated by receiving power applied by the wireless LAN connection management unit 15 performs location registration to the HLR (not shown) through the wireless LAN communication network system 30, and then transmits the call (e.g., the VoIP call) to the wireless LAN communication network system 30 in response to the call setting request inputted from the user to use the packet data service or sets the call (i.e., the VoIP call) with the transmitting terminal based on the call setting message received from the wireless LAN communication network system 30.

A control unit 17 controls the operation of the multi-mode terminal 10.

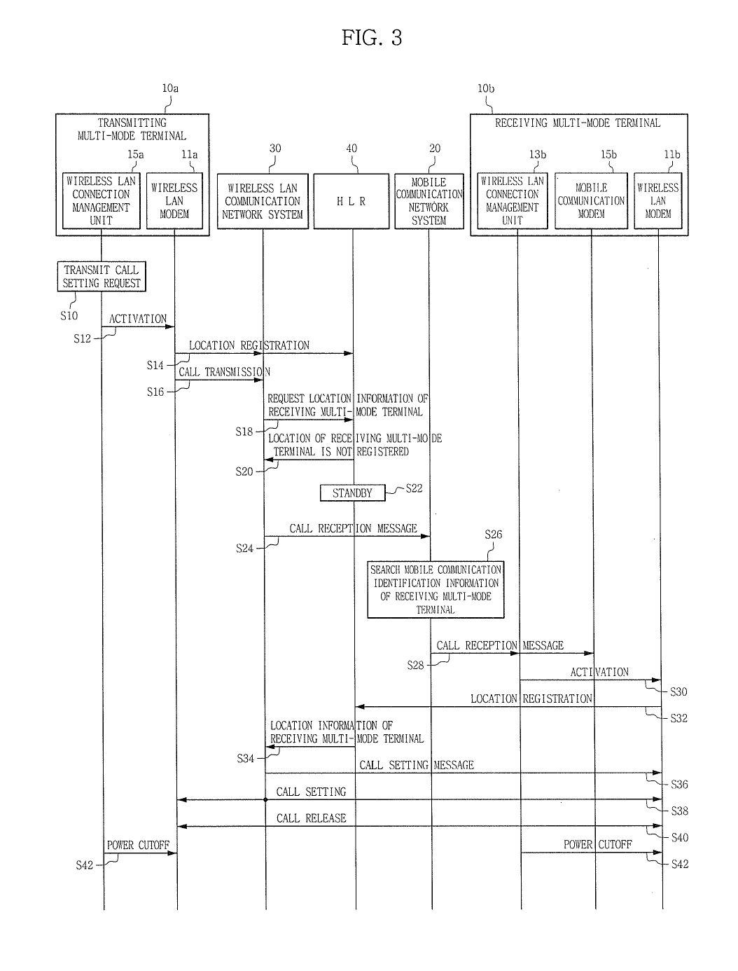

FIG. 3 is a flowchart illustrating a method for reducing power consumption of a multi-mode terminal according to an exemplary embodiment. In an exemplary embodiment, the case where a transmitting terminal and a receiving terminal are multi-mode terminals will be described as an example; however, aspects are not limited thereto such that at least one of the transmitting terminal and the receiving terminal need not be a multi-mode terminal.

First, in response to a call setting request inputted from a user to use a packet data service, such as an internet telephony service in operation S10, a wireless LAN connection management unit 15a of a transmitting multi-mode terminal 10a activates a wireless LAN modem 11a by applying power to the wireless LAN modem 11a in operation S12.

The wireless LAN modem 11a activated in operation S12 performs location registration to an HLR 40 of a wireless LAN communication network through a wireless LAN communication network system 30 in operation S14. In operation S16, the wireless LAN modem 11a transmits a call (e.g., a VoIP call) to the wireless LAN communication network system 30 in response to the call setting request inputted from the user in operation S10.

In operation S18, the wireless LAN communication network system 30 that receives the call transmitted by the transmitting multi-mode terminal 10a in operation S16 requests location information of a receiving multi-mode terminal 10b from the HLR 40 by using identification information of the receiving multi-mode terminal 10b included in the call. If the location of the receiving multi-mode terminal 10b is not registered and hence the wireless LAN communication network system 30 receives that the location of the receiving multi-mode terminal 10b is not registered as a response to a location information request from the HLR 40 in operation S20, the wireless LAN communication network system 30 transmits a call reception message to the mobile communication network system 20 in operation S24. Here, the call reception message informs the mobile communication network system 20 that the call (e.g., the VoIP call) to the receiving multi-mode terminal 10b has been received.

After the HLR 40 transmits to the wireless LAN communication network system 30 that the location of the receiving multi-mode terminal 10b is not registered as the response to the location information request in operation S20, the HLR 40 may enter a standby mode in operation S22 while location registration of the receiving multi-mode terminal 10b is performed. In operation S26, the mobile communication network system 20 that receives the call reception message from the wireless LAN communication network system 30 in operation S24 searches mobile communication identification information of the receiving multi-mode terminal 10b by using the wireless LAN identification information of the receiving multi-mode terminal 10b included in the call reception message. Then, in operation S28, the mobile communication network system 20 transmits the call reception message to the receiving multi-mode terminal 10b by using the searched mobile communication identification information.

In operation S30, a wireless LAN connection management unit 13b of the receiving multi-mode terminal 10b that receives the call reception message transmitted by the mobile communication network system 20 through a mobile communication modem 15b in operation S28 activates a wireless LAN modem 11b by applying power to the wireless LAN modem 11b based on the call reception message. In operation S32, the activated wireless LAN modem 11b performs location registration to the HLR 40 through the wireless LAN communication network system 30.

If the wireless LAN modem 11b of the receiving multi-mode terminal 10b performs location registration in operation S32, the HLR 40, which transmitted to the wireless LAN communication network system 30 that the location of the receiving multi-mode terminal 10b was not registered as the response for the location information request in operation S20 and then entered standby mode, provides location information of the receiving multi-mode terminal 10b to the wireless LAN communication network system 30 in operation S34.

The wireless LAN communication network system 30, which receives the location information of the receiving multi-mode terminal 10b from the HLR 40 in operation S34, transmits a call setting message to the receiving multi-mode terminal 10b based on the location information of the receiving multi-mode terminal 10b in operation S36. The receiving multi-mode terminal 10b sets a call (e.g., a VoIP call) with the transmitting multi-mode terminal 10a based on the call setting message received from the wireless LAN communication network system 30 in operation S38.

Thereafter, if the call (e.g., the VoIP) set between the transmitting multi-mode terminal 10a and the receiving multi-mode terminal 10b is released (S40), the transmitting multi-mode terminal 10a and the receiving multi-mode terminal 10b cut off the power applied to the wireless LAN modems 11a and 11b, respectively, in operation S42.

According to the system and method for reducing power consumption of the multi-mode terminal disclosed herein, power is cut off or a low-power state is maintained if a wireless LAN service is not used, and power is applied to a wireless LAN modem if a user requests or a call reception message is received through a mobile communication modem, thereby decreasing power consumption of the multi-mode terminal.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for reducing power consumption of a multi-mode terminal, the system comprising:
a multi-mode terminal having a mobile communication modem and a wireless local area network (LAN) modem;
a mobile communication network system that provides a mobile communication service; and
a wireless LAN communication network system that provides a packet data service,
wherein:
if the wireless LAN communication network system receives a call to the multi-mode terminal, the wireless LAN communication network system transmits a call reception message to the mobile communication network system, and the mobile communication network system transmits the call reception message received from the wireless LAN communication network system to the multi-mode terminal; and
if the multi-mode terminal receives the call reception message through the mobile communication modem while the wireless LAN modem is in a low-power state, the multi-mode terminal activates the wireless LAN modem by applying power to the wireless LAN modem.

2. The system of claim 1, wherein:
the wireless LAN communication network system requests a home location register (HLR) of location information of the multi-mode terminal by using identification information of the multi-mode terminal if the wireless LAN communication network system receives a call received to the multi-mode terminal; and
the wireless LAN communication network system transmits to the mobile communication network system a call reception message to indicate that the call has been received to the multi-mode terminal if the wireless LAN communication network system does not receive the location information of the multi-mode terminal from the HLR as a response to the location information request.

3. The system of claim 1, wherein, if the mobile communication network system receives a call reception message received to the multi-mode terminal, the mobile communication network system searches mobile communication identification information of the multi-mode terminal by using a wireless LAN identification included in the call reception message and then transmits the call reception message to the multi-mode terminal by using the searched mobile communication identification information.

4. A multi-mode terminal, comprising:
a wireless local area network (LAN) modem connected to a wireless LAN communication network system through a wireless LAN access point (AP) to perform communications;
a mobile communication modem connected to a mobile communication network system to perform communications; and
a wireless LAN connection management unit to activate a wireless LAN modem by applying power to the wireless LAN modem if the wireless LAN connection management unit receives a call reception message through the mobile communication modem while the wireless LAN modem is in a low-power state,
wherein the activated wireless LAN modem performs location registration and sets a call based on the call setting message received from the wireless LAN communication network system.

5. The multi-mode terminal of claim 4, wherein the call is with a transmitting multi-mode terminal based on the call setting message received from the wireless LAN communication network system.

6. The multi-mode terminal of claim 4, wherein the wireless LAN connection management unit controls the wireless LAN modem to be in a low-power state if the call is released.

7. A method for reducing power consumption of a multi-mode terminal, the method comprising:
activating a wireless local area network (LAN) modem of a transmitting multi-mode terminal by applying power to the wireless LAN modem in response to a call setting request inputted from a user to use a packet data service;
performing location registration through the activated wireless LAN modem of the transmitting multi-mode terminal and transmitting a call to a wireless LAN communication network system;
transmitting a call reception message from the wireless LAN communication network system that receives the call to a mobile communication network system;
transmitting the call reception message from the mobile communication network system to a receiving multi-mode terminal;
activating a wireless LAN modem of the receiving multi-mode terminal by applying power to the wireless LAN modem of the receiving multi-mode terminal; and
performing location registration through the activated wireless LAN modem of the receiving multi-mode terminal and setting a call with the transmitting multi-mode terminal based on the call setting message received from the wireless LAN communication network system.

8. The method of claim 7, further comprising: setting the wireless LAN modems from the transmitting multi-mode terminal and the receiving multi-mode terminal in low-power states if the call between the transmitting multi-mode terminal and the receiving multi-mode terminal is released.

9. A method for reducing power consumption of a multi-mode terminal, the method comprising:
receiving in a receiving multi-mode terminal a call reception message from a mobile communication network system through a mobile communication modem;
activating a wireless local area network (LAN) modem of the receiving multi-mode terminal by applying power to the wireless LAN modem of the receiving multi-mode terminal based on the received call reception message;
performing location registration through the activated wireless LAN modem of the receiving multi-mode terminal; and
receiving in the receiving multi-mode terminal a call setting message from the wireless LAN communication network system and setting a call with a transmitting multi-mode terminal.

10. A system for reducing power consumption of a multi-mode terminal, the system comprising:
a multi-mode terminal having a mobile communication modem and a wireless local area network (LAN) modem;
a mobile communication network system that provides a mobile communication service; and
a wireless LAN communication network system that provides a packet data service,
wherein:
if the wireless LAN communication network system receives a call to the multi-mode terminal, the wireless LAN communication network system transmits a call reception message to the mobile communication network system, and the mobile communication network system transmits the call reception message received from the wireless LAN communication network system to the multi-mode terminal; and
if the multi-mode terminal receives a call setting request from a user to use the packet data service while the wireless LAN modem is in a low-power state, the multi-mode terminal activates the wireless LAN modem by applying power to the wireless LAN modem.

11. The system of claim 10, wherein:
the wireless LAN communication network system requests a home location register (HLR) of location information of the multi-mode terminal by using identification information of the multi-mode terminal if the wireless LAN communication network system receives a call received to the multi-mode terminal; and
the wireless LAN communication network system transmits to the mobile communication network system a call reception message to indicate that the call has been received to the multi-mode terminal if the wireless LAN communication network system does not receive the location information of the multi-mode terminal from the HLR as a response to the location information request.

12. The system of claim 10, wherein, if the mobile communication network system receives a call reception message received to the multi-mode terminal, the mobile communication network system searches mobile communication identification information of the multi-mode terminal by using a wireless LAN identification included in the call reception message and then transmits the call reception message to the multi-mode terminal by using the searched mobile communication identification information.

13. A multi-mode terminal, comprising:
a wireless local area network (LAN) modem connected to a wireless LAN communication network system through a wireless LAN access point (AP) to perform communications;
a mobile communication modem connected to a mobile communication network system to perform communications; and
a wireless LAN connection management unit to activate a wireless LAN modem by applying power to the wireless LAN modem if the wireless LAN connection management unit receives a call setting request from a user to use a packet data service while the wireless LAN modem is in a low-power state,
wherein the activated wireless LAN modem performs location registration and sets a call based on the call setting message received from the wireless LAN communication network system.

14. The multi-mode terminal of claim 13, wherein the call is with a transmitting multi-mode terminal based on the call setting message received from the wireless LAN communication network system.

15. The multi-mode terminal of claim 13, wherein the wireless LAN connection management unit controls the wireless LAN modem to be in a low-power state if the call is released.
